(19) United States
(12) Patent Application Publication
(10) Pub. No.: US 2025/0390673 A1
(43) Pub. Date: Dec. 25, 2025

(54) THEMATIC SUMMARY GENERATION OF DIGITAL DOCUMENT DIFFERENCES

(71) Applicant: Adobe Inc., San Jose, CA (US)

(72) Inventors: Natwar Modani, Bangalore (IN); Yaswanth Sri Sai Santosh Tokala, Munich (DE); Apoorv Umang Saxena, Bangalore (IN)

(73) Assignee: Adobe Inc., San Jose, CA (US)

(21) Appl. No.: 18/750,243

(22) Filed: Jun. 21, 2024

(51) Int. Cl. G06F 40/194; G06V 30/19; G06V 30/416

(52) U.S. Cl. CPC G06F 40/194; G06V 30/19093; G06V 30/19107; G06V 30/416

(57) ABSTRACT

Thematic summary generation of digital document techniques are described. A one or more semantic groups are parsed having differences, one to another, from first and second digital documents by comparing the first and second digital documents. Text descriptions of the one or more semantic groups are acquired. The text descriptions are generated using generative artificial intelligence as implemented by at least one machine-learning model. One or more clusters are formed based on the text descriptions and a cluster description of the one or more clusters is obtained. The cluster description is generated using generative artificial intelligence as implemented by at least one machine-learning model. A thematic summary is constructed of the differences in the first and second digital documents based on the cluster description for output in a user interface.

### BACKGROUND

Digital document development often involves several rounds of changes. Examples of changes include refinement of the digital document before being finalized (e.g., incorporation of comments), repurposing of the digital document (e.g., from one audience to another audience), and so on. Accomplishing these tasks often involves an understanding of a relationship of changes that are made to various versions of the digital document, where those changes are made, and so forth.

Conventional techniques, however, involve manual interactions that rely on user navigation to various portions of the digital document to review the changes, which is time consuming and inefficient both to a user as well as in some scenarios to computational resources that implement these techniques. Challenges of these conventional techniques are further exacerbated in scenarios involving navigation through changes made by multiple collaborating authors and determination as to how changes made by the collaborators affect the digital document.

### SUMMARY

Thematic summary generation of digital document differences is described. In one or more examples, a document revision system is configurable to present differences between two or more digital documents as a thematic summary where semantically related changes are grouped together to aid human consumption, automatically and without user intervention. The document revision system does so by detecting differences between the digital documents, grouping portions of the digital documents that contain the differences, and then leverages a machine-learning model to describe the differences as a natural language textual description. The textual descriptions are clustered together (e.g., by semantic theme), which are then presented for output in a user interface. The user interface is configurable to support navigation to respective portions of the digital documents to explore individual changes, groups of the changes, and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ thematic summary generation techniques of digital document differences as described herein.

FIG. 2 depicts a system in an example implementation showing operation of a document revision system of FIG. 1 in greater detail as forming semantic groups of differences between first and second digital documents.

FIG. 3 depicts a system in an example implementation showing operation of a document revision system of FIG. 1 in greater detail as forming a thematic summary based on the semantic groups of FIG. 2.

FIG. 4 is a flow diagram depicting an algorithm as a step-by-step procedure in an example implementation of operations performable for accomplishing a result of thematic summary generation of digital document differences using generative artificial intelligence (AI) as implemented using machine learning.

FIG. 5 depicts an example implementation showing output of a thematic summary in a user interface as a side panel in a hierarchical fashion.

FIG. 6 includes an example implementation of a baseline single step template including a system prompt and a user prompt.

FIG. 7 includes an example implementation of a baseline chain-of-thought template including a system prompt and a user prompt.

FIG. 8 includes an example implementation of a single step from difference of the documents template including a system prompt and a user prompt.

FIG. 9 includes an example implementation of a two steps/one call from difference of the documents template including a system prompt and a user prompt.

FIG. 10 includes an example implementation of a first call of a two steps/two calls from difference of the documents template for both clustering and based clustering including a system prompt and a user prompt.

FIG. 11 includes an example implementation of a second call of a two steps/two calls from difference of the documents template for both clustering and embedding based clustering including a system prompt and a user prompt.

FIG. 12 includes an example implementation of a consolidation of cluster template including a system prompt and a user prompt.

FIG. 13 illustrates an example system including various components of an example device that can be implemented as any type of computing device as described and/or utilize with reference to FIGS. 1-12 to implement embodiments of the techniques described herein.

### DETAILED DESCRIPTION

### Overview

Digital document creation often involves several rounds of revisions in which changes are made to the digital document for a variety of reasons, e.g., for editing, refining, repurposing, and other revisions made to the digital document. Oftentimes, digital document creation involves a review of previous changes and familiarity of what changes have been made over time, where those changes have been made, a purpose of the changes, and so on. Consequently, review of differences between document versions is challenging in conventional scenarios that involve manual navigation through the digital document in order to develop an understanding of a relationship of the changes. The challenges are increased in collaboration scenarios in which multiple authors have made respective changes to the digital document for differing reasons.

Conventional techniques, for instance, are limited to a “compare” view that is used to indicate changes made from one document version to another. To do so, conventional compare views are limited to showing the changes individually, typically at respective portions of the digital document. While this conventional technique may be useful in relatively simple scenarios involving few changes, this conventional technique often fails in complex scenarios. Complex scenarios, for instance, include when changes applied to a relatively large digital document, when a multitude of changes and comments are made to the digital document, when the digital document is a subject of collaboration by multiple authors, and/or in scenarios involving multiple revisions over time.

Accordingly, thematic summary generation techniques are described. These techniques address conventional challenges by leveraging generative artificial intelligence (AI) in order to generate a thematic summary as a concise summary of difference between digital documents. A document revision system, for instance, is configurable to generate the thematic summary, automatically and without user intervention, by machine learning to describe differences in first and second digital documents. As a result, the document revision system is configured to reduce cognitive effort involved in understanding differences between the digital documents through use of a thematic summary that describes those differences using natural language, which is not possible in conventional techniques.

In one or more examples, a document revision system begins by extracting text information from first and second digital documents. The second digital document, for instance, is configurable as a later version of the first digital document such that changes are made to the first digital document in order to create the second digital document. Other examples are also contemplated, such as documents that are independent versions, digital documents that pertain to a similar subject but are created by different authors, and so forth. Although first and second digital documents are described, these techniques are also applicable to three or more digital documents.

The text information is configurable to include text (e.g., characters of text such as letters, numbers, punctuation marks, etc.), define properties of the text (e.g., font, size), and so forth. The text information is also configurable to include positional information of the text such as to specify a location of the text with respect to a page, which page of a digital document includes the text, and so on. The positional information is usable to support a variety of functionalities, examples of which include control of organization within the thematic summary as further described below.

The document revision system then detects differences in the text information, one to another, between the first and second digital documents. The document revision system, for instance, operates at a semantic unit level of a “word” to detect changes to the text, e.g., text that is added, removed, properties are changed, and so forth. The detected differences are codified as difference data, which is then provided as an input to a parsing module of the document revision system.

The parsing module is configurable to parse semantic groups having the differences from the first and second digital documents, respectively. The semantic groups, for instance, are parsed by copying sentences from the respective first and second digital documents that include one or more of the differences. In this way, the semantic groups provide additional context to the differences and therefore changes made to the digital documents. Thus, the differences in this example are initially expressed at a lower semantic level (e.g., word) to detect the differences and then context is added at a higher semantic level (e.g., sentence, paragraph, etc.) as part of the semantic groups.

The document revision system is then configured to acquire text descriptions of the semantic groups by making a call to a machine-learning model, e.g., a large language model (LLM). The document revision system, for instance, forms a prompt that describes one or more of the semantic groups constructed based on the differences in the digital documents, e.g., the extracted text information, the semantic groups, and so forth. In response, the document revision system receives a text description from the machine-learning model that describes, in natural language, characteristics of the respective semantic groups based on the prompt. In an implementation, the document revision system configures the prompt to include as many of the semantic groups as supported by the machine-learning model to reduce a number of calls made to the model as well as reduce latency, operational costs, and computational costs incurred through use of the machine-learning model.

The document revision system employs the text descriptions from the machine-learning model to form clusters of the changes, thereby grouping similar changes together based on common themes. The clusters are formable by the document revision system in a variety of ways. In a first example, the clusters are based on similarity of embeddings generated from the text descriptions, e.g., using Cosine similarity of vectors generated based on the text descriptions using machine learning. In a second example, the clusters are formed along with cluster descriptions by the machine-learning model, e.g., the large language model.

The document revision system, continuing with the first example, is configurable to generate a prompt that includes the text descriptions as clustered based on the embeddings as described above along with an instruction to describe (e.g., summarize or expand) the text descriptions. Continuing with the second example, the document revision system is also configurable to generate a prompt that includes the text descriptions as well as an instruction to cluster the cluster descriptions based on similarity, one to another. The prompts, in both examples, are configurable to include the text information, data describing the differences, and/or the semantic groups along with the text descriptions previously generated by the machine-learning model.

The document revision system then forms a thematic summary by finalizing descriptions of the clusters. The document revision system, for instance, generates an additional prompt to the machine-learning model to merge the descriptions together using natural language as following an overall theme of the differences based on themes corresponding to the respective clusters. In an implementation, the thematic summary is formed by the document revision system as having a format based on the positional information extracted from the digital documents to follow the format of those documents. Attributions are also generated by the document revision system that are selectable to indicate “where” the described differences occur in the first and second digital documents as well as to support navigate to those locations, e.g., as a hyperlink.

In this way, the document revision system is configurable to present differences between two or more digital documents as a thematic summary where semantically related changes are grouped together to aid human consumption, automatically and without user intervention. The document revision system does so by detecting differences between the digital documents (e.g., at a semantic word level), groups the difference (e.g., at a semantic sentence level), and then uses a machine-learning model to describe the differences as a textual description. The textual descriptions are clustered together (e.g., by semantic theme), which are then presented for output in a user interface. The user interface is configurable to support navigation to respective portions of the digital documents to explore individual changes, groups of the changes, and so forth. Further discussion of these and other examples is included in the following discussion and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Thematic Summary Generation Environment

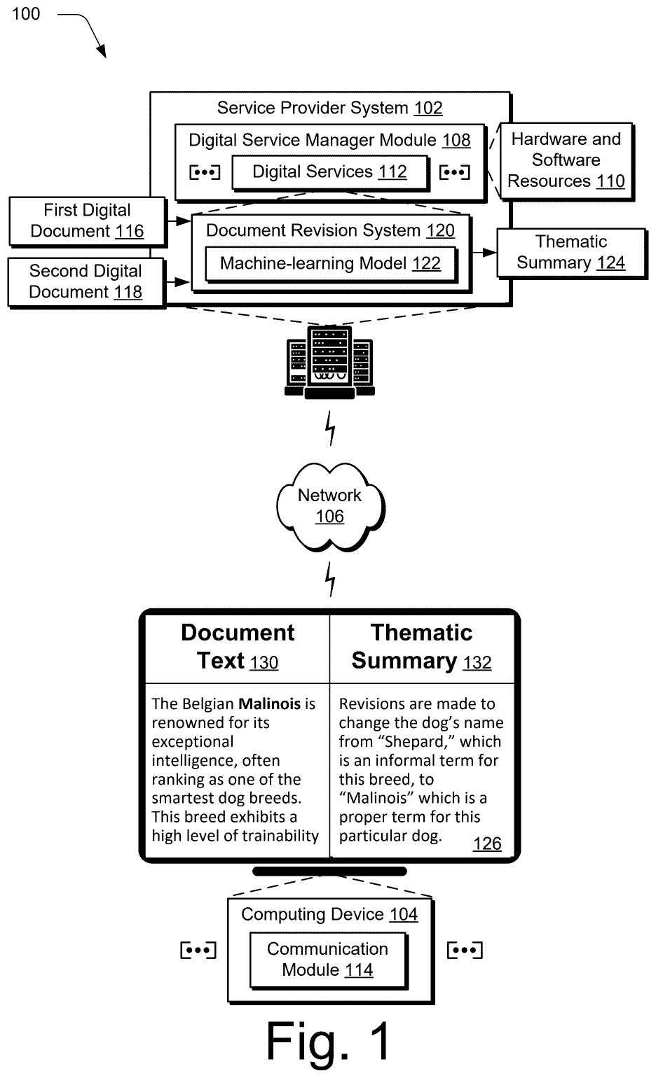

FIG. 1 is an illustration of a digital medium environment 100 in an example implementation that is operable to employ thematic summary generation techniques of digital document differences as described herein. The illustrated environment 100 includes a service provider system 102 and a computing device 104 that are communicatively coupled, one to another, via a network 106. Computing devices are configurable in a variety of ways.

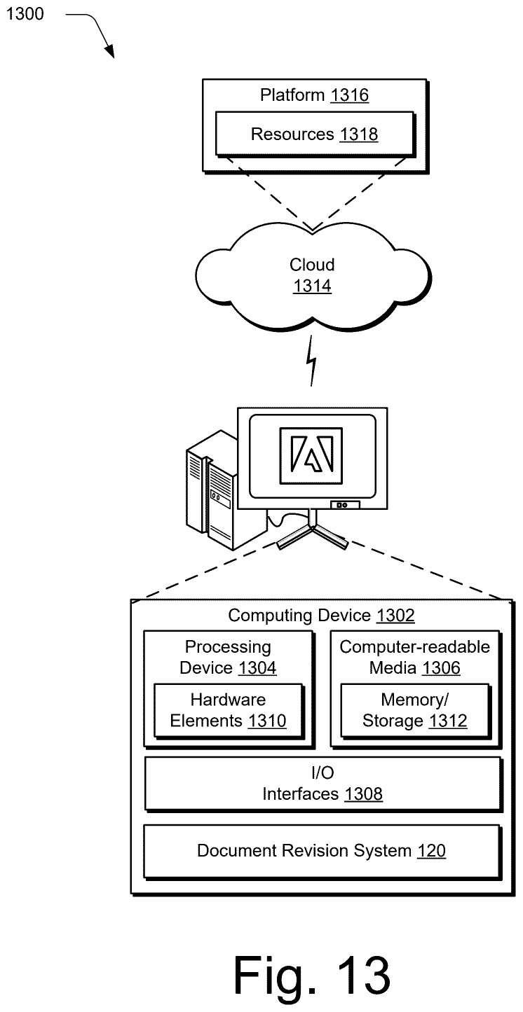

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 13.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to receive a first digital document 116 and a second digital document 118. Digital documents are configurable in a variety of ways, examples of which include webpages, portable document format, presentations, digital books, and so forth. A document revision system 120 is then illustrated as employing a machine-learning model 122 to generate a thematic summary 124 that describes differences of the first and second digital documents 116, 118 in relation to each other. The second digital document 118, for instance, may be created as a version of the first digital document 116 through making one or more changes to the first digital document 116. Other examples are also contemplated, such as independent and generally unrelated documents, documents on a similar topic but different authors, and so forth. Additionally, although execution of the document revision system 120 is shown as a digital service 112, local execution of the document revision system 120 is also contemplated, e.g., at the computing device 104 as part of the communication module 114.

As previously described, digital document creation often involves a process involving multiple revisions, often by multiple parties. Consequently, creation of the digital document also involves knowledge of what revisions are made and how those revisions affect the digital document. In such situations, a reviewer tasked with reading a second version of a document is also tasked with developing a familiarity with a first version of the document (e.g., a reviewer who wants to know what has changed from the version being read), desires a direct comparison between two versions, e.g., when a creator wants to know what has changed between two versions of a document, and so on. In such situations, typically, the reviewer is tasked with reading the full digital document even when having read previous versions of the document. Conventional “compare” views, however, are limited by showing the changes, separately, without context and are difficult to navigate in large documents.

Accordingly, the document revision system 120 is configured to generate a thematic summary 124, automatically and without user intervention, from the first digital document 116 and the second digital document 118 using a machine-learning model 122. The document revision system 120 addresses technical challenges in understanding semantic relationships between changes, especially when those changes occur at significant distances from each other in the digital documents which is not possible in conventional techniques.

The document revision system 120, for instance, is configurable to generate the thematic summary 124 to indicate semantically related changes that are grouped together to aid human consumption. To do so, the document revision system 120 detects changes between the first digital document 116 and the second digital document 118. The changes are then grouped together to form semantic groups, e.g., sentences having one or more changes parsed from the documents. The machine-learning model 122 is then employed to generate textual descriptions of the changes as grouped semantically to form the thematic summary 124 which supports output in a user interface 126 to navigate to the changes individually and/or hierarchically.

In the illustrated user interface 126, for instance, a first portion 130 includes text from the first digital document 116 and/or the second digital document 118 that is changed. A second portion 132 includes a thematic summary describing, in natural language, both what is changed and potential reasoning behind the change as determined, automatically and without user intervention, by the machine-learning model 122. In this way, the thematic summary 124 improves user efficiency in determining what is changed between documents as well as reasoning behind the changes, which is not possible in conventional techniques. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Thematic Summary Generation

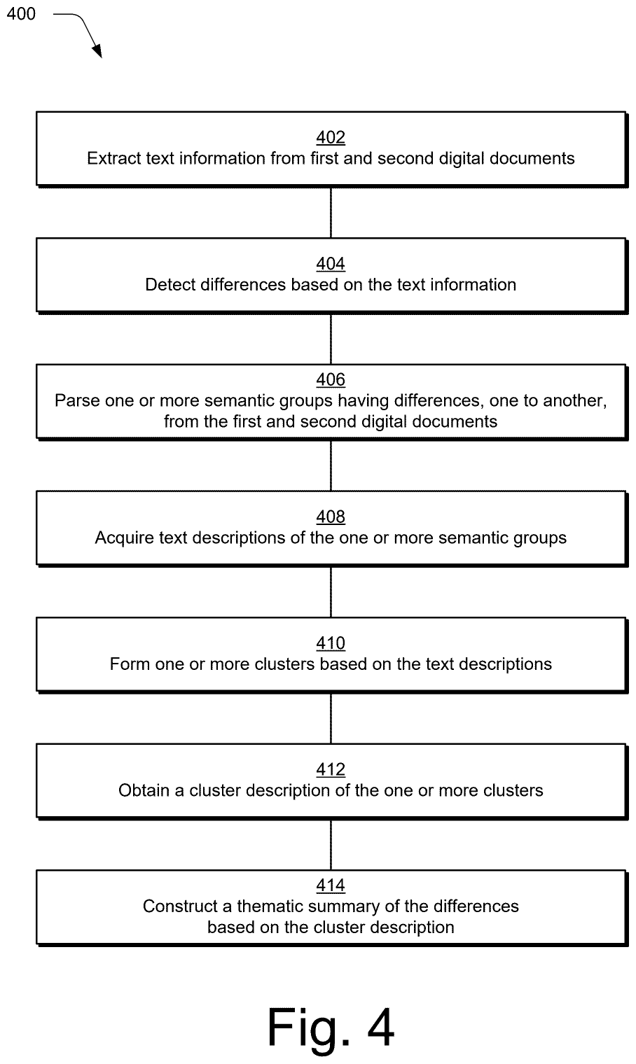

The following discussion describes thematic summary generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 4 is a flow diagram depicting an algorithm 400 as a step-by-step procedure in an example implementation of operations performable for accomplishing a result of thematic summary generation of digital document differences using generative artificial intelligence (AI) as implemented using machine learning. In portions of the following discussion, reference will be made in parallel with FIG. 4.

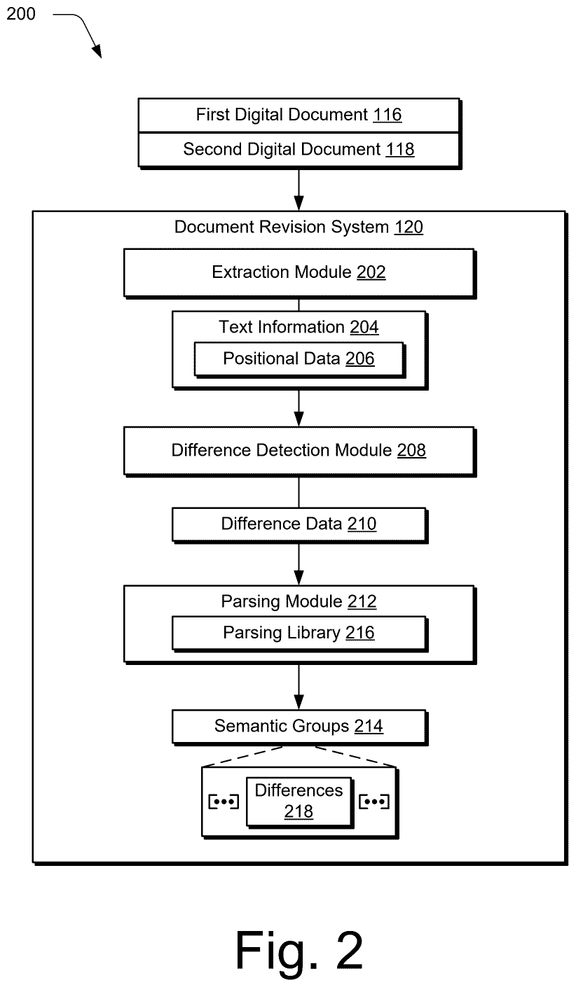

FIG. 2 depicts a system 200 in an example implementation showing operation of the document revision system 120 of FIG. 1 in greater detail as forming semantic groups of differences between first and second digital documents. To begin in this example, a first digital document 116 and a second digital document 118 are received by the document revision system 120. Although a comparison of two digital documents is described in this example, thematic summaries may also be generated by the document revision system 120 for three or more digital documents. The digital documents may take a variety of forms, examples of which include a portable document format, word processing document, text file, presentation, spreadsheets, transcripts, and so forth.

An extraction module 202 is then employed by the document revision system 120 to extract text information 204 from the first digital document 116 and the second digital document 118 (block 402). The extraction module 202, for instance, utilizes extraction application programming interfaces (APIs) to obtain the text from the digital documents as part of the text information 204. The text information 204 also includes information about a text type, (e.g., whether the text is part of a heading, paragraph, list, and so forth) a font used by the text, and so forth. The text information 204, for instance, is extracted at a “word” level from the digital documents.

The extraction module 202 is also configurable to extract positional data 206 describing relative position of the text within respective digital documents. The positional data 206, for instance, is configurable to define a coordinate of a bounding box of a respective item of text within a page of a digital document, a page with respect to digital document, a particular slide in a presentation, page of a book, and so forth. The positional data 206 is usable as previously described in support of a variety of functionality, such as to define an ordering of themes within the thematic summary 124 as further described below.

The text information 204 is then provided as an input to a difference detection module 208 that is configured to generate difference data 210 by detecting differences in the text information between the first and second digital documents 116, 118 (block 404). The difference data 210, for instance, is used to identify difference in the text, font, text type, positional data, and so forth between the first and second digital documents based on the text information 204.

To do so in one or more examples, the positional data 206 utilizes a string matching algorithm and begins by creating a list of two tuples. The first element in the tuple is an indicator of a type of change detected, e.g., “−1” for text deleted from the first digital document 116 version into the second digital document 118, “0” for text that is unchanged, and “1” for text that is added in the first digital document 116 to form the second digital document 118. The difference detection module 208 then performs a semantic/efficiency cleanup and consolidates the changes at a “word” level.

The difference detection module 208, for instance, when detecting a change from “took” to “sooth” initially generates the following:
(−1, ‘t’), (1, ‘s’), (0, ‘oo’), (−1, ‘k’), (1, ‘th’).
   The difference detection module 208 then converts these differences to a word level as follows:
(−1, “took”) and (1, “sooth”)
   thereby increasing an ability for a human to understand the changes as well as increase accuracy of the machine-learning model 122 in generating a text description as further described below. In an implementation, the difference detection module 208 is also configured to generate the difference data 210 such that sequences of tuples having a same indicator are combined, e.g., tuples having “−1” or “1” as a change indicator are arranged to combine the change indicators for “−1” and then combine the change indicators for “1” to increase understanding.

The difference data 210 is passed as an input to a parsing module 212 that is configured to parse one or more semantic groups 214 having differences, one to another, from the first and second digital documents 116, 118 by comparing the first and second digital documents (block 406), e.g., using the difference data 210. To do so, the parsing module 212 creates the one or more semantic groups 214 as a sufficiently large semantic unit having enough context to make sense of the changes, e.g., at a “sentence” level.

The parsing module 212, for instance, utilizes a parsing library 216 to parse both the first digital document 116 and the second digital document 118. The tuples defined in the difference data 210 from the difference detection module 208 and sentence boundary information from the parsing library 216 are used to parse sentences having differences 218, respectively, from the first digital document 1186and the second digital document 118 to form the semantic groups 214. Thus, a semantic group 214 is configurable to include one or more differences 218 and provide context at a higher semantic level than that expressed by the difference data 210, solely. The one or more semantic groups 214 are then usable as part of generative artificial intelligence to form the thematic summary 124, further discussion of which is included in the following description and shown in corresponding figures.

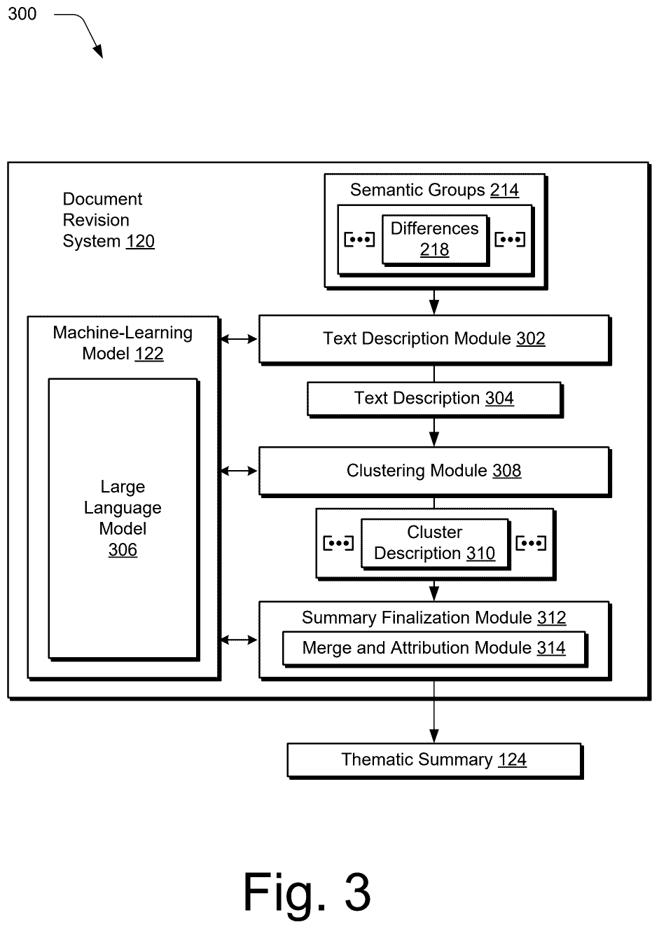

FIG. 3 depicts a system 300 in an example implementation showing operation of the document revision system 120 of FIG. 1 in greater detail as forming a thematic summary based on the semantic groups of FIG. 2. A text description module 302 receives the semantic groups 214, e.g., as sentence level semantic context of the differences. The text description module 302 then acquires text descriptions 304 of the semantic groups 214. The text descriptions 304 are generated using generative artificial intelligence as implemented by at least one machine-learning model (block 408).

The text description module 302, for instance, generates a prompt that includes the one or more semantic groups 214 detailing the differences 218. The prompt is then processed by a large language model 306 or other type of machine-learning model 122 to generate the text descriptions 304. In an implementation, the text description module 302 is configured to include as many semantic groups 214 as supported into a single call to the large language model 306 (e.g., based on token limit including input and output tokens) to reduce operational cost and latency. The prompt includes an instruction to generate a natural language description of the differences 218 detailed by the one or more semantic groups 214.

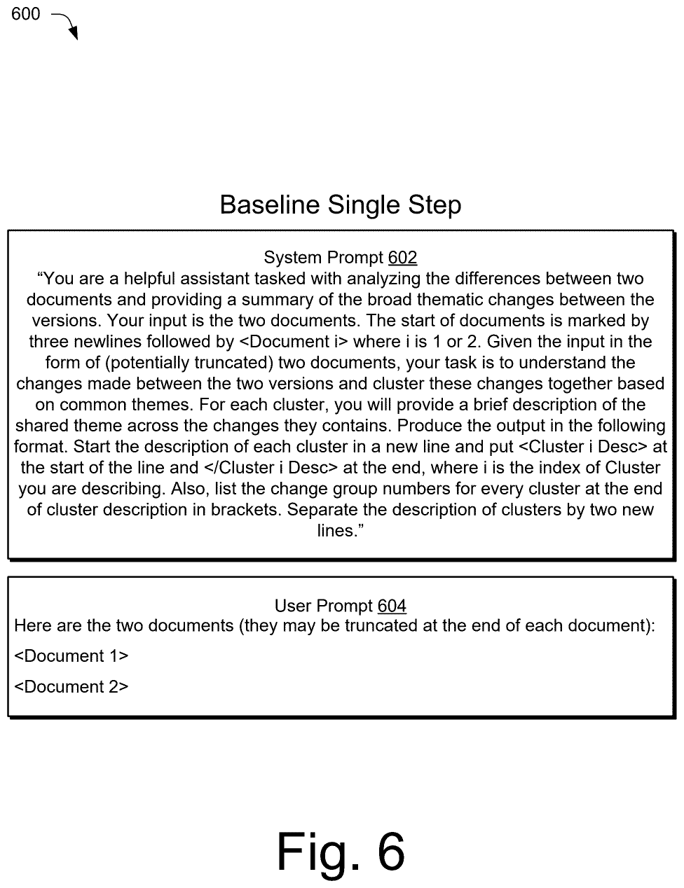

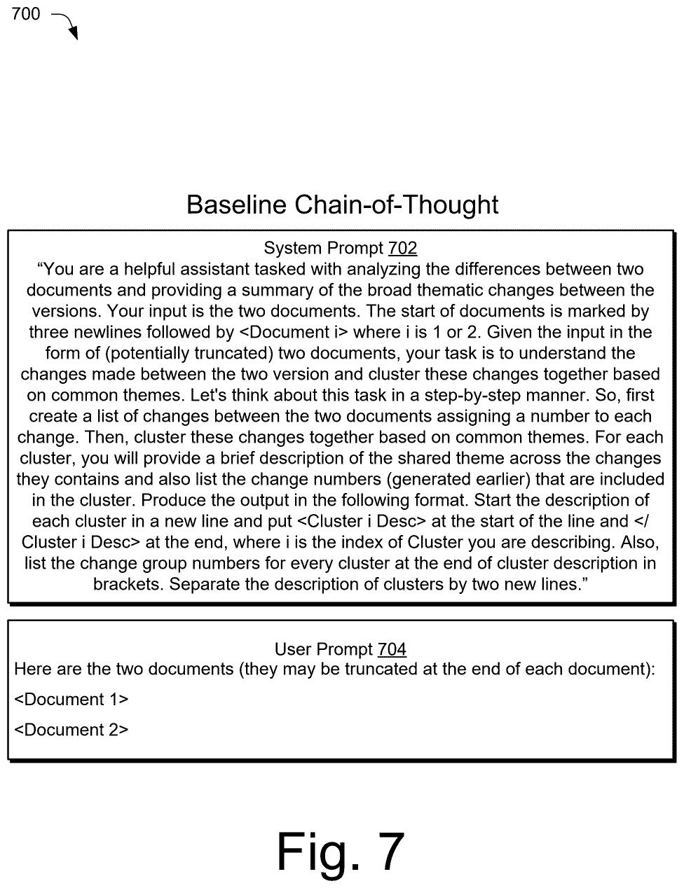

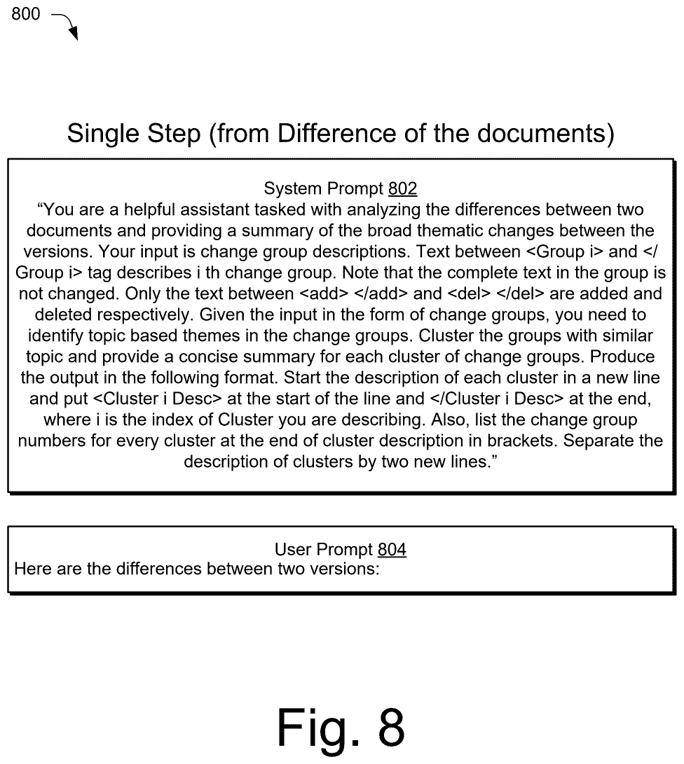

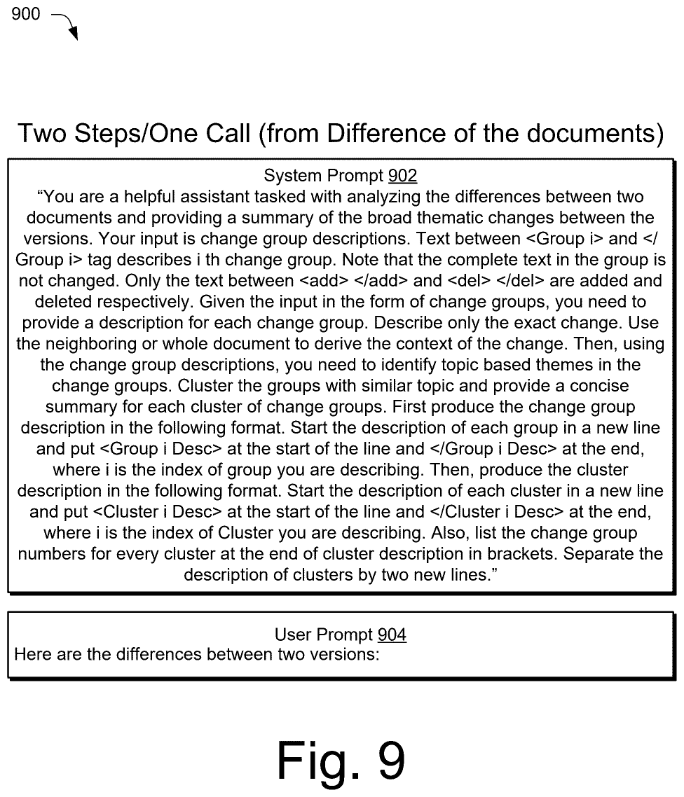

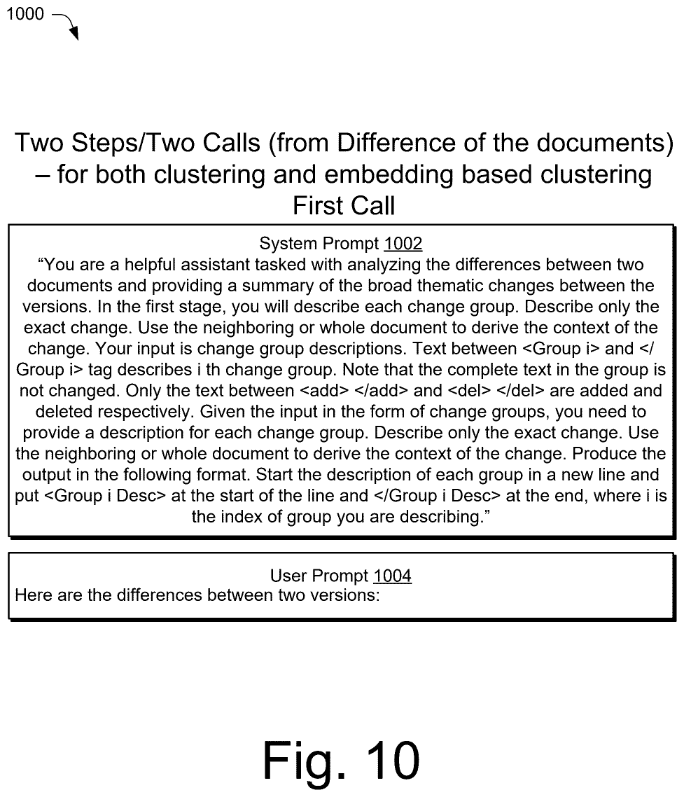

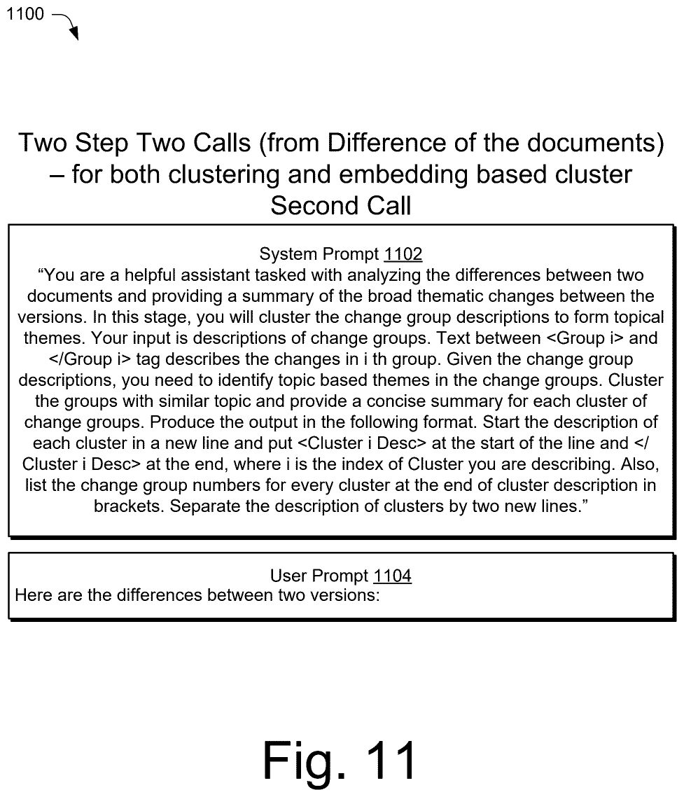

Examples of prompt templates are included in FIGS. 6−12. FIG. 6 includes an example implementation 600 of a baseline single step template including a system prompt 602 and a user prompt 604. FIG. 7 includes an example implementation 700 of a baseline chain-of-thought template including a system prompt 702 and a user prompt 704. FIG. 8 includes an example implementation 800 of a single step from difference of the documents template including a system prompt 802 and a user prompt 804. FIG. 9 includes an example implementation 900 of a two steps/one call from difference of the documents template including a system prompt 902 and a user prompt 904. FIG. 10 includes an example implementation 1000 of a first call of a two steps/two calls from difference of the documents template for both clustering and embedding based clustering including a system prompt 1002 and a user prompt 1004. FIG. 11 includes an example implementation 1100 of a second call of a two steps/two calls from difference of the documents template for both clustering and embedding based clustering including a system prompt 1102 and a user prompt 1104.

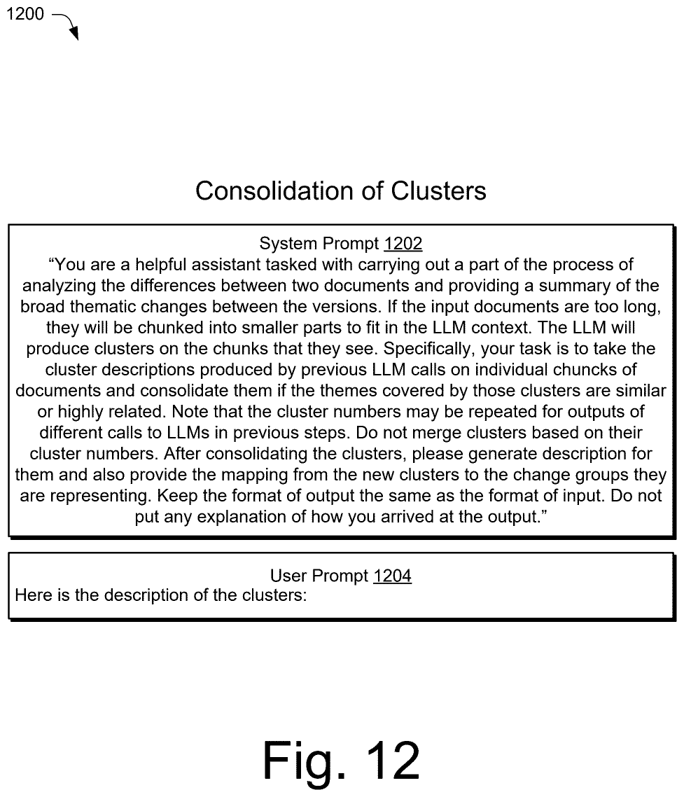

FIG. 12 includes an example implementation 1200 of a consolidation of cluster template including a system prompt 1202 and a user prompt 1204. The document revision system 120, for instance, is configured to detect whether the first or second input document has a size over a threshold amount supported by the at least one machine learning model. If so, the first or second input document are separated into portions that are then used for acquiring the text descriptions, which are then consolidated into the groupings based on similarity as described below.

A clustering module 308 is also included as part of the document revision system 120 and representative of functionality to form one or more clusters based on the text descriptions (block 410) and obtain a cluster description of the one or more clusters. The cluster description 310 is also generated using generative artificial intelligence as implemented by the machine-learning model 122 (block 412), e.g., the large language model 306. The clustering module 308 is configurable to form the clusters and obtain the cluster descriptions in a variety of ways.

The clustering module 308, for instance, is configurable to use the text descriptions 304 of each of the one or more semantic groups 214 as well as actual group content (e.g., the sentence) as part of a prompt to call the large language model 306 to create (e.g., hierarchical) clusters of changes, and also generate a cluster description 310 for each cluster. The clusters are thematic groupings of changes. For example, a change to a name of a character in a story may lead to many changes in names, pronouns and other related actions in multiple different locations in the document. However, the clustering step is usable to summarize the change as a single cluster (or subcluster, depending on if there are other similar changes in the document) saying the name of the character is changed. Thus, in this example a prompt to the large language model 306 is used to both form the cluster and obtain the cluster description.

In another example, the clustering module 308 is configured to generate embeddings (e.g., as vectors) from the text descriptions 304 and/or one or more semantic groups 214. The clustering module 308 then forms the clusters by determining similarity of the embeddings (e.g., Cosine similarity), one to another, in the embedding space. The clusters based on the embeddings are then used by the clustering module 308 as a prompt to form the cluster description 310.

In scenarios in which the text descriptions 304 and/or the one or more semantic groups 214 do not fit in a single prompt, the prompt is generated by the cluster module 308 which maximizes a number of one or more semantic groups 214 and/or text descriptions 304 included. Another call may then be made to the large language model 306 to consolidate these cluster descriptions. If embeddings were used for forming preliminary clusters, prompts are filled with units of those clusters, e.g., for particular types of one or more semantic groups 214. In that case, consolidation of clusters is performed by then aggregating the clusters.

The cluster description 310 is then provided to a summary finalization module 312 to construct the thematic summary 124 of the differences in the first and second digital documents for presentation in a user interface (block 414). The summary finalization module 312, for instance, is configurable to organize the cluster description 310 based on the positional data 206 such that the organization follows an overall format of the digital documents. The positional data 206 is also configurable for use in navigation and other user interface aids. The summary finalization module 312 also includes a merge and attribution module 314 that is configured to attribute the changes to respective portions of the digital documents.

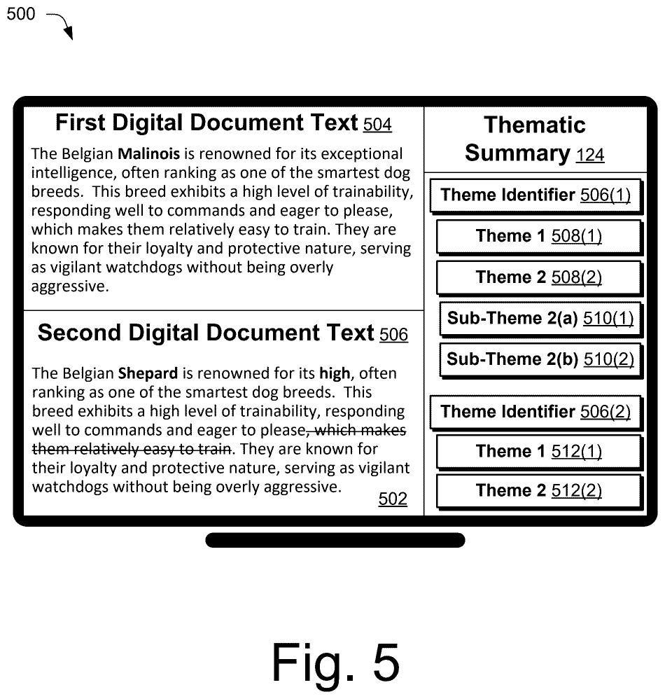

FIG. 5 depicts an example implementation 500 showing output of a thematic summary 124 in a user interface 502 as a side panel in a hierarchical fashion. The user interface 502 includes a first portion 504 including text from the first digital document 116 and a second portion 506 having text from the second digital document 118. The sidebar includes representations of portions of the thematic summary 124 as arranged in a hierarchical order by theme identifier 506(1), 506(2), themes 508(1), 508(2), 512(1), 512(2), and sub-themes 510(1), 510(2) as appropriate. The representations are hyperlinked to corresponding text of the first and second digital documents 116, 118. For example, if the description of a cluster is selected, a color-coded bar is usable to show a location of the changes corresponding to this cluster and navigation arrows. If a selection is received via the user interface 502 for a cluster group, the user interface 502 navigates to the location of change and also displays the insertions and deletions.

### Example System and Device

FIG. 13 illustrates an example system generally at 1300 that includes an example computing device 1302 that is representative of one or more computing systems and/or devices that implement the various techniques described herein. This is illustrated through inclusion of the document revision system 120. The computing device 1302 is configurable, for example, as a server of a service provider, a device associated with a client (e.g., a client device), an on-chip system, and/or any other suitable computing device or computing system.

The example computing device 1302 as illustrated includes a processing device 1304, one or more computer-readable media 1306, and one or more I/O interface 1308 that are communicatively coupled, one to another. Although not shown, the computing device 1302 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1304 is representative of functionality to perform one or more operations using hardware. Accordingly, the processing device 1304 is illustrated as including hardware element 1310 that is configurable as processors, functional blocks, and so forth. This includes implementation in hardware as an application specific integrated circuit or other logic device formed using one or more semiconductors. The hardware elements 1310 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1306 is illustrated as including memory/storage 1312 that stores instructions that are executable to cause the processing device 1304 to perform operations. The computer-readable storage medium is configured for storing instructions that, responsive to execution by the processing device, causes the processing device to perform operations. The memory/storage 1312 represents memory/storage capacity associated with one or more computer-readable media. The memory/storage 1312 includes volatile media (such as random access memory (RAM)) and/or nonvolatile media (such as read only memory (ROM), Flash memory, optical disks, magnetic disks, and so forth). The memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1302. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1310. The computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing device 1304. The instructions and/or functions are executable/operable by one or more articles of manufacture (for example, one or more computing devices 1302 and/or processing devices 1304) to implement techniques, modules, and examples described herein.

The techniques described herein are supported by various configurations of the computing device 1302 and are not limited to the specific examples of the techniques described herein. This functionality is also implementable all or in part through use of a distributed system, such as over a “cloud” 1314 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 abstracts resources and functions to connect the computing device 1302 with other computing devices. The platform 1316 also serves to abstract scaling of resources to provide a corresponding level of scale to encountered demand for the resources 1318 that are implemented via the platform 1316. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

In implementations, the platform 1316 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
parsing, by a processing device, one or more semantic groups having differences, one to another, from first and second digital documents by comparing the first and second digital documents;
forming, by the processing device, one or more clusters based on text descriptions of the one or more semantic groups;
obtaining, by the processing device, a cluster description of the one or more clusters, the cluster description generated using generative artificial intelligence as implemented by at least one machine-learning model; and
constructing, by the processing device, a thematic summary of the differences in the first and second digital documents based on the cluster description for output in a user interface.

2. The method as described in claim 1, further comprising acquiring, by the processing device, the text descriptions of the one or more semantic groups, the text descriptions generated using generative artificial intelligence as implemented by at least one machine-learning model.

3. The method as described in claim 1, wherein the forming of the one or more clusters includes determining similarity of embeddings generated based on the text descriptions.

4. The method as described in claim 1, wherein the forming of the one or more clusters is performed using generative artificial intelligence as implemented by the at least machine-learning model as part of the obtaining of the cluster description.

5. The method as described in claim 4, wherein the forming is based on a prompt provided to the one or more machine-learning models that includes the one or more semantic groups and the text descriptions.

6. The method as described in claim 1, further comprising:
extracting, by the processing device, text information from the first and second digital documents; and
detecting, by the processing device, the differences in the text information between the first and second digital documents.

7. The method as described in claim 6, wherein:
the extracting includes extracting positional information describing positions associated with the text information in relation to the first or second digital documents, respectively; and
the constructing of the thematic summary is organized at least in part based on the positional information.

8. The method as described in claim 7, wherein the positional information indicates a bounding box coordinate or a page with respect to the first or second digital documents.

9. The method as described in claim 6, wherein:
the text information is extracted at a word level from the first and second digital documents; and
the one or more semantic groups are parsed at a sentence level from the first and second digital documents.

10. The method as described in claim 6, wherein the text information includes text, a text type, and font.

11. The method as described in claim 6, wherein the detecting the differences uses a string matching algorithm based on tuples configurable to employ a deletion indicator indicating text deletion, an unchanged indicator indicating text is unchanged, or an addition indicator indicating text addition.

12. A computing device comprising:
a processing device, and
a computer-readable storage medium storing instructions that, responsive to execution by the processing device, causes the processing device to perform operations including:
parsing one or more semantic groups from first and second digital documents having differences, one or another;
acquiring text descriptions of the one or more semantic groups, the text descriptions generated using generative artificial intelligence as implemented by at least one machine-learning model;
obtaining one or more clusters and a cluster description of the one or more clusters, the one or more clusters and the cluster description generated using generative artificial intelligence as implemented by the at least one machine-learning model based on the text descriptions; and
presenting a thematic summary of the differences in the first and second digital documents based on the cluster description and grouped based on the one or more clusters as themes for output in a user interface.

13. The computing device as described in claim 12, wherein the thematic summary includes a hierarchical arrangement describing the differences based on positional information of the differences within the first or second digital documents, respectively.

14. The computing device as described in claim 12, wherein the operations further comprise:
extracting text information from the first and second digital documents; and
detecting the differences in the text information between the first and second digital documents.

15. The computing device as described in claim 14, wherein:
the extracting includes extracting positional information describing positions associated with the text information in relation to the first or second digital documents, respectively; and
the thematic summary is organized at least in part based on the positional information.

16. The computing device as described in claim 12, wherein the acquiring is based on a prompt provided to the at least one machine-learning model that includes the text descriptions.

17. One or more computer-readable storage media storing instructions that, responsive to execution by a processing device, causes the processing device to perform operations comprising:
acquiring text descriptions of differences in first and second digital documents, the text descriptions generated using generative artificial intelligence as implemented by at least one machine-learning model;
forming one or more clusters based on the text descriptions;
obtaining a cluster description of the one or more clusters, the cluster description generated using generative artificial intelligence as implemented by at least one machine-learning model; and
constructing a thematic summary of the differences in the first and second digital documents based on the cluster description for output in a user interface.

18. The one or more computer-readable storage media as described in claim 17, further comprising detecting whether the first or second input document have a size over a threshold amount supported by the at least one machine learning model, responsive to the detecting, separating the first or second input document into portions, and wherein the acquiring of the text descriptions is performed for the portions.

19. The one or more computer-readable storage media as described in claim 17, wherein the forming of the one or more clusters is performed using generative artificial intelligence as implemented by the at least machine-learning model as part of the obtaining of the cluster description.

20. The one or more computer-readable storage media as described in claim 17, wherein the operations further comprise:
extracting text information from the first and second digital documents;
detecting the differences in the text information between the first and second digital documents; and
parsing one or more semantic groups from first and second digital documents having the differences, one or another, and wherein the acquiring is based on the one or more semantic groups.
